(19) United States
(12) Patent Application Publication
(10) Pub. No.: US 2026/0319524 A1
(43) Pub. Date: Oct. 15, 2026

(54) HYDROFOIL-BASED TRANSPORT SYSTEM

(71) Applicants: Alain THÉBAULT, Genève (CH); DEVLP, Attiches (FR)

(72) Inventors: Alain THÉBAULT, Geneve (CH); Laurent PERRIER, Attiches (FR)

(21) Appl. No.: 19/138,519

(22) PCT Filed: Dec. 12, 2023
(86) PCT No.: PCT/IB2023/062557

§ 371 Date: Jun. 12, 2025

(30) Foreign Application Priority Data
Dec. 14, 2022 (CH) CH001498/2022
Dec. 14, 2022 (FR) FR2213317

(51) Int. Cl. G05D 1/698; B63B 1/30; B63B 35/00; G05D 1/227; G05D 105/22; G05D 107/00; G05D 109/30

(52) U.S. Cl. CPC G05D 1/6985; B63B 1/30; G05D 1/2279; B63B 2035/007; B63B 2035/008; G05D 2105/22; G05D 2107/27; G05D 2109/34

(57) ABSTRACT

Disclosed is a marine transport system including a first hydrofoil boat (P), referred to as the lead hydrofoil boat, and at least a second hydrofoil boat(S), referred to as the follower hydrofoil boat, communication means (TCP, TCS) allowing an exchange of information between the lead hydrofoil boat (P) and the follower hydrofoil boat(S), the lead hydrofoil boat (P) including a cockpit, a control unit (UCI) and geolocation means (GP), the follower hydrofoil boat(S) including a control unit (UC2) and geolocation means (GS), said transport system being configured to operate at least in an imitation mode, in which the lead hydrofoil boat (P) is controlled by a driver and the follower hydrofoil boat(S) reproduces the motional behaviour of the lead hydrofoil boat, and in a differential mode in which the motional behaviour of the follower hydrofoil boat(S) is controlled by the lead hydrofoil boat (P).

### TECHNICAL FIELD AND PRIOR ART

The present invention relates to a hydrofoil-based transport system, including at least two hydrofoils boat.

A hydrofoil boat is a boat whose hull is equipped with foils. The speed of the boat generates hydrodynamic lift on the foil(s), capable of lifting the hull partially or completely out of the water, which reduces the hull's drag and the power required for cruising speed.

This reduction in required power allows for a decrease in the energy needed to move the boat.

Given the ecological challenges the world faces, the hydrofoil boat appears to be a very interesting alternative for maritime transport.

Electric-powered hydrofoil boats have been developed and contribute to the transition towards reducing fossil fuel use. Such hydrofoil boats also generate very low noise compared to traditional boats, offering a remarkable transport experience for passengers.

This type of hydrofoil boat is particularly suitable for transporting small groups of people, for example, those traveling to leisure facilities, such as hotels located at the sea-side, on islands, or on the sea with bungalows built on stilts. In this latter case, guests are brought by boat to their bungalow together with their luggage.

Luggage can be loaded onto the same boat as the passengers; however, to improve the experience and comfort of passengers during their journey on a hydrofoil, it is preferable for the luggage to be transported by another means. It is conceivable to use another boat to transport the luggage, but this implies a second driver, increasing operating costs for the hotel complex.

Hydrofoil boats can also be used to allow tourists to take organized tours in marine areas with remarkable comfort. To avoid too many passengers per hydrofoil, several hydrofoils are used, requiring multiple drivers.

### SUMMARY OF THE INVENTION

It is therefore an objective of the present application to present a system that does not have the above disadvantages.

The stated objective is achieved by a transport system including at least two hydrofoil boats, a first hydrofoil boat being a lead or master hydrofoil boat and the other hydrofoil boat(s) being follower or slave hydrofoil boats. Thus, the follower hydrofoil boat(s) follow the lead hydrofoil boat, eliminating the need for a person to pilot each hydrofoil boat. Furthermore, the master and slave hydrofoil boats are such that the driver of the master hydrofoil boat can at any time take control of the slave hydrofoil boat and pilot it independently of the master hydrofoil boat. For example, during docking, while the master hydrofoil boat is at the dock, the pilot remotely directs the slave hydrofoil boat to dock.

In a particularly advantageous embodiment where the foils are retractable, for example, in the event of rough seas, it can be envisaged that the master hydrofoil boat continues to move on the foil(s) while the slave hydrofoil boat does not deploy its foil(s) and rests on its hull.

Thus, in the case of transporting passengers and their luggage, the master hydrofoil boat can transport the passengers, and the slave hydrofoil boat can transport the luggage, directly following the passengers. They do not have to wait for their luggage, and the risk of loss is reduced.

In the case of tourist transport during a tour, a convoy of hydrofoils can be envisaged, with the lead hydrofoil boat being the master and the others being the slaves.

A subject-matter of the present invention is a marine transport system including a first hydrofoil boat, referred to as the lead hydrofoil boat, and at least a second hydrofoil boat, referred to as the follower hydrofoil boat, with communication means allowing an exchange of information between the lead hydrofoil boat and the follower hydrofoil boat, the lead hydrofoil boat including a cockpit, a control unit, and geolocation means, the follower hydrofoil boat including a control unit and geolocation means, said transport system being configured to operate at least in an imitation mode wherein the lead hydrofoil is controlled by a driver and the follower hydrofoil boat reproduces the motional behavior of the lead hydrofoil boat, and in a differential mode wherein the motional behavior of the follower hydrofoil boat is controlled by the lead hydrofoil boat.

Advantageously, in the differential mode, the motional behavior of the follower hydrofoil boat is directly controlled by the driver.

Preferably, the lead hydrofoil boat is configured to send to the control unit of the follower hydrofoil boat at least the positioning, direction, and speed of the lead hydrofoil boat, and the control unit of the follower hydrofoil boat is configured to calculate the trajectory of the follower hydrofoil boat based on the direction and speed of the lead hydrofoil boat.

For example, the communication means are dedicated short-range communication means configured to ensure a direct exchange of information between the lead hydrofoil boat and the follower hydrofoil boat.

In an advantageous example, the lead hydrofoil boat includes at least one retractable hydrofoil, and the follower hydrofoil boat includes at least one retractable hydrofoil.

According to an additional feature, the transport system is configured to operate in another mode, referred to as partial imitation mode, wherein the follower hydrofoil boat reproduces only part of the motional behavior of the lead hydrofoil boat. In partial imitation mode, the control unit of the follower hydrofoil can be configured to keep the hydrofoil boat of the follower hydrofoil boat in a retracted position, while the control unit of the lead hydrofoil boat may have deployed the hydrofoil of the lead hydrofoil boat.

Advantageously, the cockpit is a specific human-machine interface and allows the follower hydrofoil boat to be controlled in differential mode.

For example, the lead hydrofoil boat is configured for transporting people, and the follower hydrofoil is configured for transporting objects, such as luggage.

Another subject-matter of the present invention is a method of operating a transport system according to the invention, comprising:
in an imitation mode,
Sending information by the lead hydrofoil boat to the follower hydrofoil boat via the communication means, this information being, for example, the direction and speed of the lead hydrofoil boat,
Sending an acknowledgment of receipt of this information from the follower hydrofoil boat to the lead hydrofoil boat,
Taking into account said information by the control unit of the follower hydrofoil boat to calculate the trajectory and navigation conditions of the follower hydrofoil boat,
in a differential mode,
Sending control instructions by the lead hydrofoil boat to the follower hydrofoil boat, for example, by the driver of the lead hydrofoil boat,
Execution of the control instructions by the follower hydrofoil boat.

### BRIEF DESCRIPTION OF THE DRAWINGS

The present application will be better understood with the aid of the following description and the accompanying drawings wherein:

FIG. 1 is a schematic representation of an example of a system according to the invention including two hydrofoil boats,

FIG. 2A is a side view of an example of a lead hydrofoil boat that can be implemented in the system according to the invention in a high-speed navigation configuration,

FIG. 2B is a side view of the lead hydrofoil boat from FIG. 2A in a low-speed configuration.

FIG. 3 is a side view of an example of a follower hydrofoil boat that can be implemented in a transport system from FIG. 1,

FIG. 4 is a schematic top view of the transport system moving in imitation or clone mode,

FIG. 5 is a schematic top view of the transport system in a differential mode, also referred to as drone mode,

FIG. 6 is a side view of another example of a transport system according to the invention.

### DETAILED DESCRIPTION OF EMBODIMENTS

In the present application, the terms “master” and “lead” are considered synonyms, and the terms “slave” and “follower” are also considered synonyms; the terms “boat” and “hydrofoil boat” are used interchangeably.

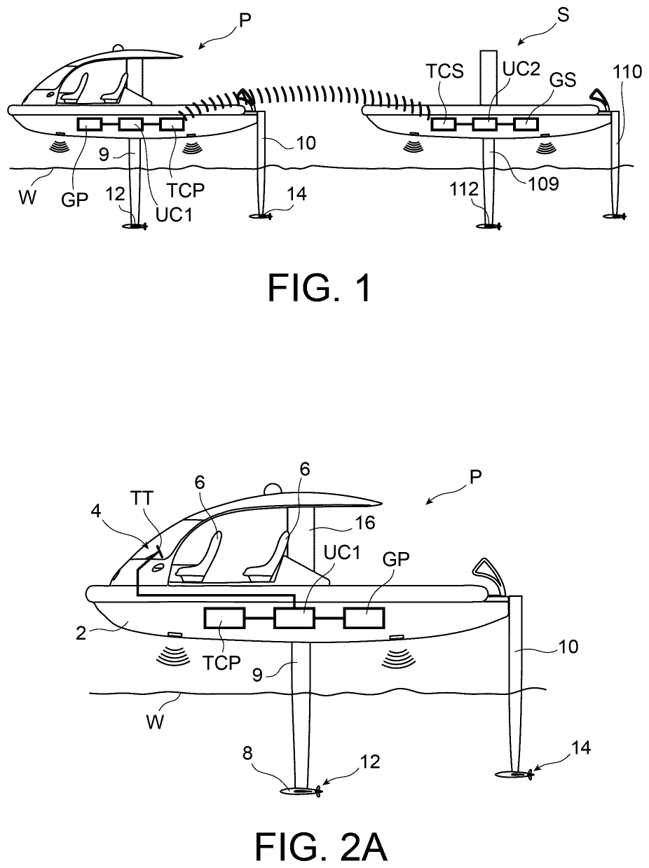

In FIG. 1, a schematic representation of an example of a marine transport system according to the invention can be seen.

In this example, the marine transport system includes two hydrofoil boats, a lead hydrofoil boat P, and a follower hydrofoil boat S.

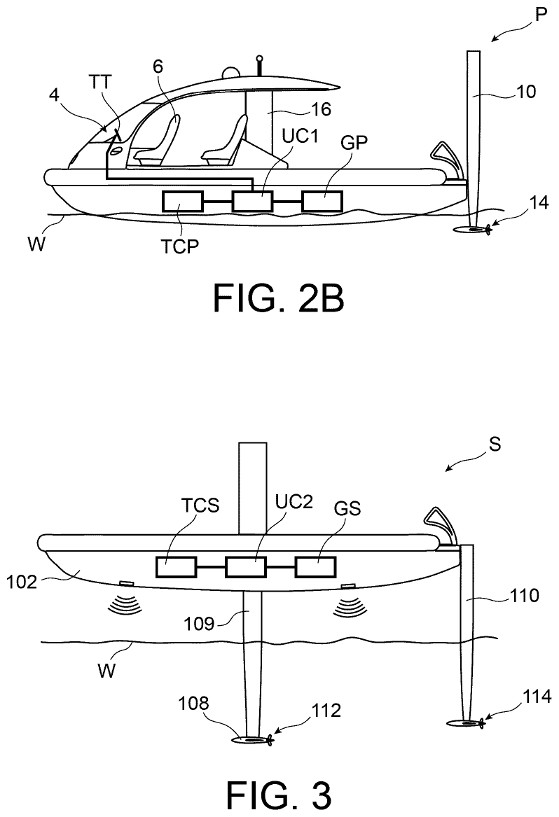

In FIGS. 2A and 2B, the lead hydrofoil P is shown in detail, including a hull 2, a cockpit 4, seats 6 for passengers, a hydrofoil 8 attached to the end of an underwater mast 9, a rudder 10, and propulsion means 12, 14. As a variant, the lead boat may include one or more propulsion means.

W denotes the water surface.

In the example shown, the propulsion means 12, 14 include an electric motor and propellers or turbines. In this example, propulsion means 12 are provided at the hydrofoil, and propulsion means 14 are provided at the rudder.

Very advantageously, the underwater mast equipped with the hydrofoil is retractable, as is the rudder, facilitating movement in shallow water and docking in marinas. An arrangement 16 is provided on the boat's floor at the underwater mast's location, receiving the underwater mast in the retracted position.

In a deployed configuration, when the underwater mast 9 is submerged, the hydrofoil 8 extends orthogonally to the longitudinal direction of the hull 2. Very advantageously, in a retracted configuration, when the underwater mast 9 is housed in the arrangement 16, the hydrofoil 8 extends in the longitudinal direction of the hull.

During the hydrofoil's ascent, it pivots around the underwater mast's axis to align with the hull's longitudinal direction.

Preferably, the hull's bottom is shaped to accommodate the hydrofoil when it is in the retracted position.

The follower hydrofoil boat S, visible in FIG. 3, has a structure relatively similar to that of the lead hydrofoil boat P. It includes a hull 102, a hydrofoil 108 attached to the end of an underwater mast 109, a rudder 110, and propulsion means 112, 114. Alternatively, the follower boat may include one or more propulsion means.

In the example shown, the propulsion means 112, 114 include an electric motor and propellers. In this example, propulsion means 112 are provided at the hydrofoil, and propulsion means 114 are provided at the rudder.

Very advantageously, the underwater mast 109 equipped with the hydrofoil 108 is retractable, as is the rudder 110, facilitating movement in shallow water and docking in marinas. An arrangement 116 is provided on the boat's floor at the underwater mast's location, receiving the underwater mast in the retracted position.

In this example, the follower hydrofoil boat S does not include a cockpit or passenger seats. It is intended for luggage transport and has the shape of a barge. It includes a flat floor to allow for luggage storage, and luggage securing means are advantageously provided.

The lead hydrofoil boat P includes an electronic control unit UC1 or central computer, at least one position sensor for the underwater mast, and a rudder position sensor. The lead hydrofoil boat P also includes all the measurement elements typically equipping a boat to ensure safe and regulatory navigation. The control unit UC1 is connected to the propulsion means and the control station. A maneuver by the driver by means of the cockpit is transmitted to the propulsion means and the various equipment of the lead boat by the control unit UC1.

The cockpit can be a traditional cockpit with a steering wheel. Preferably, the cockpit includes a human-machine interface, such as a screen or touch tablet TT connected to the control unit UC1, by means of which the driver gives piloting instructions and chooses modes.

The follower hydrofoil boat includes a control unit UC2 and the measurement elements typically equipping a boat to ensure safe navigation.

The lead hydrofoil boat P and the follower hydrofoil boat S also include satellite geolocation means GP, GS, respectively, allowing localization within a few meters, for example, around 3 meters.

The lead hydrofoil boat and the follower hydrofoil include communication means between them TCP, TCS. Preferably, these means are short-range communication means implementing a technology called “dedicated short-range communications” or DSRC. These communication means are particularly suitable for direct vehicle-to-vehicle communication or V to V (around ten meters). An example of such communication means is described in the document “Vehicle to vehicle data transfer and communication using LI-FI technology,” Anbalagan et al. in materialstoday: PROCEEDINGS, vol. 45, Part7, 2021, pages 5925-5933.

These means are radio communication means that allow very localized communication. Furthermore, they do not interfere with other communication systems.

The communication means TCP of the lead hydrofoil P include a lead transmitter and a lead receiver, and the communication means TCS of the follower hydrofoil boat S include a follower transmitter and follower receiver that communicate via electronic transmission.

The lead transmitter is configured to send information and instructions to the control unit UC2 of the follower hydrofoil boat via the follower receiver, and the follower transmitter is configured to send information to the control unit UC1 of the lead hydrofoil boat via the lead receiver.

According to the invention, the transport system is configured so that in a first operating mode, referred to as imitation or clone mode, the follower hydrofoil S reproduces the motional behavior of the lead hydrofoil boat P, and in a second operating mode, referred to as differential or drone mode, the follower hydrofoil boat S follows instructions from the cockpit and has a motional behavior that is different from that of the lead hydrofoil boat P.

In imitation mode, the control unit UC1 sends to the control unit UC2 via the lead transmitter and the follower receiver the trajectory of the lead hydrofoil boat, which pro-cesses this information and calculates the trajectory of the follower hydrofoil boat. Preferably, the transmission is direct between the lead transmitter and the follower receiver, i.e., in V to V, which allows for a shortened exchange time, increased reactivity, and enhanced transmission security. As a variant, the transmission can be done via a third-party device, for example, via a local server or a remote cloud. This variant is conceivable in areas offering good internet network coverage. Furthermore, it may be configured such that the cloud can be used to process all or part of certain tasks as long as the communication time is accepta-ble and communication security is ensured.

This trajectory is, for example, obtained by satellite geolocation means. The control unit UC2 commands all the means involved in the movement of the follower hydrofoil boat, such as propulsion means, the rudder, and the hydrofoil, so that they reproduce the trajectory of the lead hydrofoil boat while maintaining a distance between the lead hydrofoil boat and the follower hydrofoil boat. The distance is chosen to ensure the safety of the boats and based on the maximum communication distance between the boats.

Furthermore, this distance can vary depending on weather conditions. Indeed, in the event of strong swell, it is contemplated that this distance may be increased.

The precision of satellite geolocation is sufficient to manage the distance between the boats. Indeed, it is not required to strictly maintain this distance; it can vary by a few meters. A safety margin is then provided to avoid any risk of collision.

Using satellite geolocation to maintain the distance between the boats avoids the need to implement sensors between the boats, which is particularly advantageous as such sensors are very difficult to implement in a marine environment.

Communication between the lead boat and the follower boat is carried out, for example, as follows.

The lead transmitter sends an information frame to the follower receiver at a certain frequency, for example, one to several dozen times per second.

The information contained in the frame includes at least the direction of the lead boat, the speed of the lead boat, and possibly the location of the lead boat. Advantageously, the state of the hydrofoil is also transmitted, i.e., a deployed state or a retracted state.

Preferably, information on speed and direction is obtained by geolocation means. Alternatively, this information is obtained by means embedded in the lead boat.

When the follower receiver receives this information, the follower transmitter sends an acknowledgment confirming receipt and consideration of this information.

The control unit UC2 uses this information and the geolocation data of the follower boat to deduce the movement characteristics of the follower boat so that it reproduces the same trajectory while maintaining a certain distance. It should be noted that the instructions sent to the propulsion means 112 and the rudder 110 of the follower boat S take into account the mass of the follower boat and other characteristics of the follower boat that affect its movement.

This loop communication continues throughout the movement in imitation mode.

The information frame also allows for information transfer from the follower boat to the lead boat, such as a breakdown, information on navigation conditions, for example, an increase in swell. Thus, the control unit UC1 is always aware of the state and navigation conditions of the follower boat.

Other information can be sent to the follower boat, such as turning on navigation lights, deploying a retractable roof in case of rain. This information is then processed by the control unit UC2 as needing to be reproduced.

It should be noted that, preferably, the stability of the follower boat is automatically managed by the equipment embedded in the follower boat, so the driver of the lead boat does not have to manage it, especially since they are at a distance from the lead boat.

This direct communication mode between the two boats offers robust and secure operation.

Nevertheless, preferably, it may be configured to have computer security means, also called cybersecurity means, to increase the operational security of the transport system by securing communications between the two boats and preventing any third-party intrusion into their embedded electronic architectures.

Imitation can be partial. In certain situations, it is desired that the behavior of the lead boat is not reproduced identically. For example, the driver decides that the follower boat should not or cannot imitate the lead boat, for example, they consider that its load is too heavy and it cannot deploy its hydrofoil, wherein they send an instruction to the control unit UC2 not to deploy the hydrofoil. Thus, when the lead boat moves at a speed sufficient to move on the hydrofoil, the follower boat reproduces the trajectory of the lead boat and possibly other behaviors of the lead boat but moves on its hull. In this configuration, the follower boat sends a signal to the lead boat as soon as the distance between the two boats exceeds a limit value, and the lead boat then reduces its speed to reduce the distance.

The differential mode will now be described.

According to the invention, the follower boat can be directly controlled by the lead boat, for example, by the driver of the lead boat so that the follower boat moves in a way that is different from that of the lead boat, for example, during docking.

Indeed, when the lead boat docks at a quay, it stops, and the follower boat then stops behind the lead boat at a certain determined distance. To also dock the follower boat, it can be controlled to perform a docking maneuver while the lead boat is stationary. Furthermore, docking will be done at a location that is different from that of the lead boat. For this, the driver, by means of the human-machine interface, “takes control” and sends specific instructions directly to the control unit UC2 of the follower boat so that the follower boat performs particular maneuvers. In other words, the follower boat is then remotely controlled by the driver. These commands can be transmitted using short-range communication means.

This instruction to the follower boat can be sent manually by the driver or automatically by the control unit UC1, for example, if it receives information from the control unit UC2 on the mass of the luggage and decides that the hydrofoil of the follower boat should not be deployed.

Alternatively, a message is sent to the driver via the human-machine interface, who decides whether or not to command the control unit UC2 to prohibit the deployment of the hydrofoil.

This type of instruction can take into account several parameters, the mass of the luggage, weather conditions, such as wind speed, wave height, etc.

Advantageously, in imitation mode, it is envisaged that the follower boat will not be able to overtake the lead boat. Thus, means are implemented to ensure that the follower boat is always kept behind the lead boat unless a quay maneuver requires it.

Preferably, all information related to the navigation of the follower boat is displayed or at least accessible in the human-machine interface of the lead boat so that the driver has a complete understanding of the follower boat's status. It may be configured such that the relative position of the two boats is displayed, for example, as a top view representation showing the follower boat and the lead boat or any other visualization that could be obtained with or without the help of cameras embedded on the follower boat.

An example of the transport system's movement will now be described.

The transport system is, for example, used by a hotel with bungalows spread over the water in a bay, wishing to transport its guests to their bungalow along with their luggage.

The lead boat and the follower boat are docked on the coast. The hydrofoils are in the raised position, as are the rudders.

Guests board the lead boat, and luggage is loaded onto the follower boat. The lug-gage's mass is checked. Other conditions are checked, and it is considered that they are such that the hydrofoil of the follower boat can be deployed. The location of the follower boat for luggage loading may be distant from that of the lead boat. The positioning at this location may have been commanded by the driver of the lead boat in differential mode.

The transport system is ready to move to the bungalow.

The imitation mode is activated either by the driver or automatically. If the location of the follower boat is distant from that of the lead boat, it may be configured such that it automatically joins the lead boat.

The driver starts the propulsion means of the lead boat, which begins to move forward. By imitation, the control unit activates the propulsion means and begins to move. The start of the follower boat's movement may occur after the start of the lead boat's movement to allow for the required safety distance.

When the water depth is sufficient, the driver deploys the hydrofoil of the lead boat. The information is sent to the control unit UC2 of the follower boat, which by imitation orders the deployment of the hydrofoil of the follower boat.

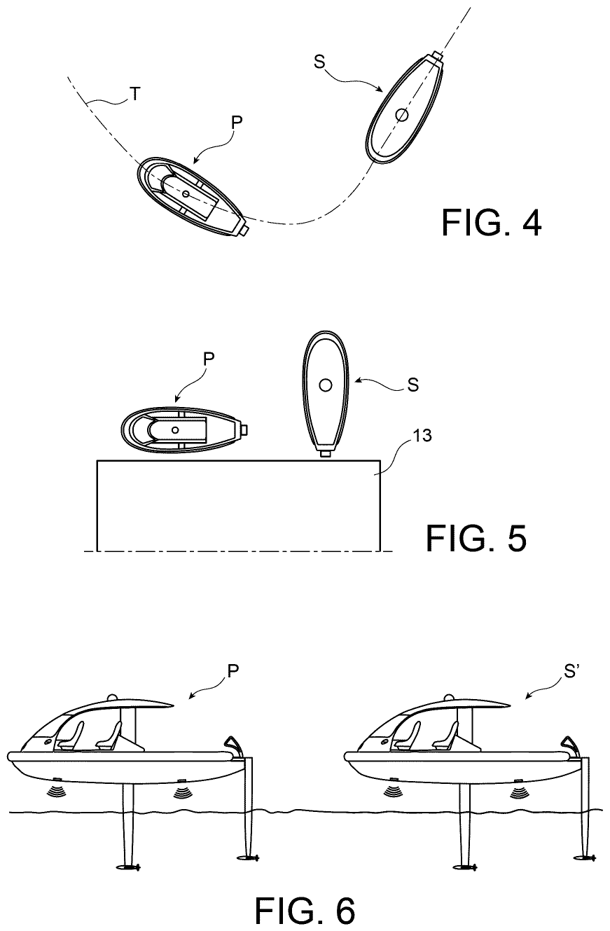

When the speed of the lead boat is sufficient, the hull lifts, and the lead boat enters “flight mode”. The follower boat has the same behavior by imitation. Each boat autono-mously manages its stability. In FIG. 4, a schematic representation of the transport system's movement can be seen, with the lead boat having trajectory T and the follower boat imitating trajectory T.

The two boats move in convoy, and the follower boat follows the trajectory of the lead boat. At any time, possibly following a warning issued to the control unit UC1, the driver can manually send an instruction to the follower boat to modify its behavior based on external events, or the control unit UC1 can do so automatically. The cases of automatic interventions by the control unit UC1 are pre-recorded in the memory of the control unit UC1.

When the convoy reaches the bungalow B, the lead boat P positions itself parallel to the bungalow and stops, and the follower boat also stops. The driver then switches to differential mode and takes control of the follower boat. The driver, for example, using the human-machine interface, commands the movement of the follower boat, for example, to dock so as to position its stern towards the bungalow and facilitate luggage unloading (FIG. 5). Alternatively, the follower boat can be parked very close to the lead boat without considering the distance set during movements. During movement in differential mode, the driver has a visual of the follower boat.

It should be noted that communication between the follower boat and the lead boat is permanent, i.e., even when the two boats are docked, and at least as long as the boats are electrically powered.

A transport system including more than one follower boat does not fall outside the scope of the present invention. In this case, the human-machine interface is configured to allow the selection of the follower boat(s) to which the differential mode is to be applied.

In FIG. 6, another example of a transport system according to the invention can be seen, wherein the follower boat S′ is a passenger transport boat. The operation is similar to that described above.

It may be configured such that each boat transports passengers and their luggage.

It will be understood that the term luggage can also mean goods, and the follower boat could be used, for example, to transport supplies.

Furthermore, it will be understood that a lead boat that does not transport people other than the driver does not fall outside the present invention.

A transport system wherein the luggage is transported by the lead boat and the passengers by the follower boat does not fall outside the scope of the present invention.

Moreover, it will be understood that the transport system according to the invention can implement any type of hydrofoil boat, equipped with retractable hydrofoils or not, and having different shapes. Furthermore, the transport system can include hydrofoil boats of different models.

Additionally, a transport system wherein the follower boat is not a hydrofoil but a traditional boat does not fall outside the scope of the present invention.

By means of the invention, it is possible to create modular marine transport systems whose capacity and purpose can be very easily adapted according to needs. Indeed, they can suitable for transporting passengers only, passengers and luggage/goods, or luggage/goods only, by adapting the follower boats.

Moreover, only one driver is required in the case of a convoy of passenger boats; it can be envisaged for a person to be provided in each follower boat just to ensure passenger safety.

1. A marine transport system including a first hydrofoil boat, called the lead hydrofoil boat, and at least one second hydrofoil boat, called the follower hydrofoil boat, a communication system allowing an exchange of information between the lead hydrofoil boat and the follower hydrofoil boat, the lead hydrofoil boat including a cockpit, a control unit and a geolocation device, the follower hydrofoil boat including a control unit and a geolocation device, said transport system being configured to operate at least in an imitation mode wherein the lead hydrofoil boat is controlled by a driver and the follower hydrofoil boat reproduces the movement behavior of the lead hydrofoil boat, and in a differentiated mode wherein the movement behavior of the follower hydrofoil boat is controlled by the lead hydrofoil.

2. The marine transport system according to claim 1, wherein in the differentiated mode the movement behavior of the follower hydrofoil boat is directly controlled by the driver.

3. The marine transport system according to claim 1, wherein the lead hydrofoil boat is configured to send to the control unit of the follower hydrofoil boat at least a positioning, direction, and speed of the lead hydrofoil boat and the control unit of the follower hydrofoil boat is configured to calculate the trajectory of the follower hydrofoil boat based on the direction and speed of the lead hydrofoil boat.

4. The marine transport system according to claim 1, wherein the communication system is a dedicated short-range communication system configured to ensure a direct exchange of information between the lead hydrofoil boat and the follower hydrofoil boat.

5. The marine transport system according to claim 1, wherein the lead hydrofoil boat includes at least one retractable hydrofoil, and the follower hydrofoil boat includes at least one retractable hydrofoil.

6. The marine transport system according to claim 1, configured to operate in another mode, called partial imitation mode, wherein the follower hydrofoil boat reproduces only part of the movement behavior of the lead hydrofoil boat.

7. The marine transport system according to claim 5, configured to operate in another mode, called partial imitation mode, wherein the follower hydrofoil boat reproduces only part of the movement behavior of the lead hydrofoil boat and wherein in partial imitation mode, the control unit of the follower hydrofoil boat is configured to keep the hydrofoil of the follower hydrofoil boat in a retracted position, while the control unit of the lead hydrofoil boat has deployed the hydrofoil of the lead hydrofoil boat.

8. The marine transport system according to claim 1, wherein the cockpit is a specific human-machine interface and allows the follower hydrofoil boat to be controlled in differentiated mode.

9. The marine transport system according to claim 1, wherein the lead hydrofoil boat is configured to transport people and the follower hydrofoil boat is configured to transport of objects, for example, luggage.

10. A method of operating a transport system according to claim 1 including:
in an imitation mode,
Sending information by the lead hydrofoil boat to the follower hydrofoil boat by the communication means system, this information being, for example, the direction and speed of the lead hydrofoil boat,
Sending an acknowledgment of receipt of this information from the follower hydrofoil boat to the lead hydrofoil boat,
Considering said information by the control unit of the follower hydrofoil boat to calculate the trajectory and navigation conditions of the follower hydrofoil boat,
in a differentiated mode,
Sending control instructions by the lead hydrofoil boat to the follower hydrofoil boat, for example, by the driver of the lead hydrofoil boat,
Execution of the control instructions by the follower hydrofoil boat.
